(19) United States
(12) Patent Application Publication
(10) Pub. No.: US 2010/0141400 A1
(43) Pub. Date: Jun. 10, 2010

(54) LOWER POWER DISCOVERY AND WAKE UP USING SERVICE SET IDENTIFIER PROBABILISTIC SCANNING SYNCHRONIZATION VERIFICATION AND OPTIONAL SENSOR

(75) Inventors: Andrei Radulescu, San Diego, CA (US); Peter H. Rauber, Del Mar, CA (US); Sanjiv Nanda, San Diego, CA, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/620,586

(22) Filed: Nov. 17, 2009

Related U.S. Application Data
(60) Provisional application No. 61/116,281, filed on Nov. 19, 2008.

(51) Int. Cl. H04Q 5/22

(52) U.S. Cl. 340/10.33

(57) ABSTRACT

Processes to achieve low power discovery and wake-up in the presence of desired 802.11 coverage are disclosed. In one aspect, probabilistic scanning for 802.11 SSID triggers is provided. In another aspect, the 802.11 Access Point (AP) is equipped with a Bluetooth inquiring device, which initiates the wake-up process with a special inquiry access code (IAC). The special IAC can comprise the AP's 802.11 channel. Additional optional sensors (GPS, Gyroscope, odometer, etc) are provided such that probabilistic scanning reduces power consumption and improves the likelihood that an 802.11 channel scan will find a desired SSID. A Bluetooth inquiry allows a discovery process to either wake-up immediately, or ascertain the need for host wake-up by exchanging further information with the AP. Probabilistic scanning allows the use of sensors and historical or pre-loaded information to improve the probability that 802.11 scanning is not required on individual channels, further driving down power needs.

### CLAIM OF PRIORITY UNDER 35 U.S.C. §119

The present Application for Patent claims priority to Provisional Application No. 61/116,281 entitled “LOW POWER DISCOVERY AND WAKE UP USING SERVICE SET IDENTIFIER PROBABILISTIC SCANNING SYNCHRONIZATION VERIFICATION AND OPTIONAL SENSORS” filed Nov. 19, 2008, and assigned to the assignee hereof and hereby expressly incorporated by reference herein.

### BACKGROUND

1. Field

The present invention relates generally to wireless communications systems, and more specifically to the extension of battery lifetime in Bluetooth equipped wireless communications devices.

2. Background

Battery lifetime is a chief concern in portable Bluetooth 802.11 computing devices, such as Ultra Mobile Personal Computers (UMPCs) and Personal Digital Assistants (PDAs). Battery lifetime can extended by keeping the host processor asleep whenever possible. It is useful for such computing devices to be aware when they enter 802.11 network coverage, and wake-up the host processor, if needed, thus eliminating the need for the user to manually check for coverage. Wake-up conditions must be sophisticated, varying from the existence of a network to complex conditions such as the existence of an urgent e-mail, availability of a particular kind of service, etc.

Traditional wake-up solutions require the existence of alternative interfaces other than 802.11 to initiate wake-up, the presence of full-blown additional processors, or host processor hierarchies for wake-up initiation. Some solutions restricted to 802.11-based wake-ups are extremely inflexible (WoWLAN, AMD Magic packet).

There is therefore a need in the art for a Bluetooth wake-up solution that provides for probabilistic 802.11 channel scanning and/or a special Bluetooth Inquiry Access Code (IAC) to ensure that the discovery process consumes very low power.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 illustrates an overview of an exemplary implementation of a trigger scanning low power wake up process;

FIG. 2 details an exemplary 802.11 configuration component of the trigger scanning low power wake up process;

FIG. 3 details an exemplary network coverage polling component of the trigger scanning low power wake up process;

FIG. 4 details an exemplary probability calculation of the coverage polling component of the trigger scanning low power wake up process;

FIG. 5 details an exemplary synchronization component of the trigger scanning low power wake up process;

FIG. illustrates an overview of an exemplary implementation an Inquiry Access Code low power wake up process;

FIG. 7 is an exemplary messaging diagram for an IAC low power discovery and wakeup process via Bluetooth interface;

FIG. 8 is an exemplary messaging diagram for an IAC process via Bluetooth interface;

FIG. 9 is a flowchart illustrating an exemplary use of synchronization token information by network coverage Access Points;

FIG. 10 is a block diagram of an exemplary wireless network communication system; and

FIG. 11 is a block diagram of an exemplary wireless device that can be used to provide a Bluetooth low power discovery process.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The word “Bluetooth” refers to the 802.15 specification developed by the IEEE for a wireless personal area network (WPAN), which is a personal, short distance area wireless network for interconnecting devices centered around an individual person's workspace. WPANs address wireless networking and mobile computing devices such as PCs, PDAs, peripherals, cell phones, pagers and consumer electronics. WPANs are also called short wireless distance networks.

The words “WiFi” and “802.11” refer to the 802.11x family of specifications developed by the IEEE for wireless LAN (WLAN) technology. 802.11 specifies an over-the-air interface between a wireless client and a base station or between two wireless clients.

The term “access terminal” (AT), “wireless device”, or “wireless terminal” as used herein are also commonly referred to as a mobile station (MS), user equipment (UE), cellular telephone, personal communication system (PCS), wireless laptop computer, access terminal, or other terminology. A an access terminal or wireless device may be a cellular telephone, a wireless modem, a wireless module, a telemetry device, a personal digital assistant (PDA), a laptop with wireless access, or any other wireless communication device. The terms access terminal, wireless terminal and wireless device are not to be limited to any particular apparatus.

The apparatus and methodology disclosed herein may be used in the context of various wireless networks such as a Code Division Multiple Access (CDMA) network, a Time Division Multiple Access (TDMA) network, a Frequency Division Multiple Access (FDMA) network, an Orthogonal Frequency Division Multiple Access (OFDMA) network, a network supporting a combination of the aforementioned technologies, a network with wide area network (WAN) coverage as well as wireless local area network (WLAN) coverage, or any other wireless networking scheme.

A CDMA network may implement one or more CDMA radio access technologies (RATs) such as Wideband CDMA (W-CDMA), cdma2000, or other CDMA RATs. Cdma2000 RAT comprises IS-2000, IS-856, and IS-95 standards incorporated herein by reference. A TDMA network may implement one or more TDMA RATs such as Global System for Mobile Communications (GSM), Digital Advanced Mobile Phone System (D-AMPS), or other TDMA RAT. D-AMPS RAT comprises IS-136 and IS-54 standards incorporated herein by reference. W-CDMA and GSM technical specifications are described in public “3rd Generation Partnership Project” (3GPP) consortium documents. Cdma2000 technical specifications are described in public “3rd Generation Partnership Project 2” (3GPP2) consortium documents.

Bluetooth computing devices such as portable media players must locate network connectivity opportunities while simultaneously conserving battery power for their applications and services. Traditionally, the device's host (main) processor must drain power resources in order to be kept awake so that network hotspots can be located, while peripherals are turned off or switched to low power modes of operation. Alternatively, traditional Bluetooth devices put the host processor to sleep and then utilize power consuming alternative channels to search for network coverage availability and wake the host processor when connectivity is available.

The following disclosure defines a means of extending the battery life of a portable Bluetooth, or 802.15, computing device or portable media player (PMP) with an 802.11, or Wifi, interface by ensuring that the host processor is only awake and consuming power when necessary (i.e. when within designated 802.11 network coverage, or when needed by the user). The 802.11 interface wakes up the host processor when desired 802.11 coverage is detected without the need for additional hardware or chipsets required to operate alternative channel interfaces. Since available coverage is not always desirable, depending on encryption, subscription, or availability of certain services or data, in a first embodiment (herein referred to as the trigger scanning embodiment) a set of defined wake-up triggers and a synchronization token increase the probability of detecting desirable network coverage, services or data. In another embodiment (herein referred to as the Inquiry Access Code embodiment), network servers advertise the availability of network coverage and services to Bluetooth devices in order to initiate device wake up.

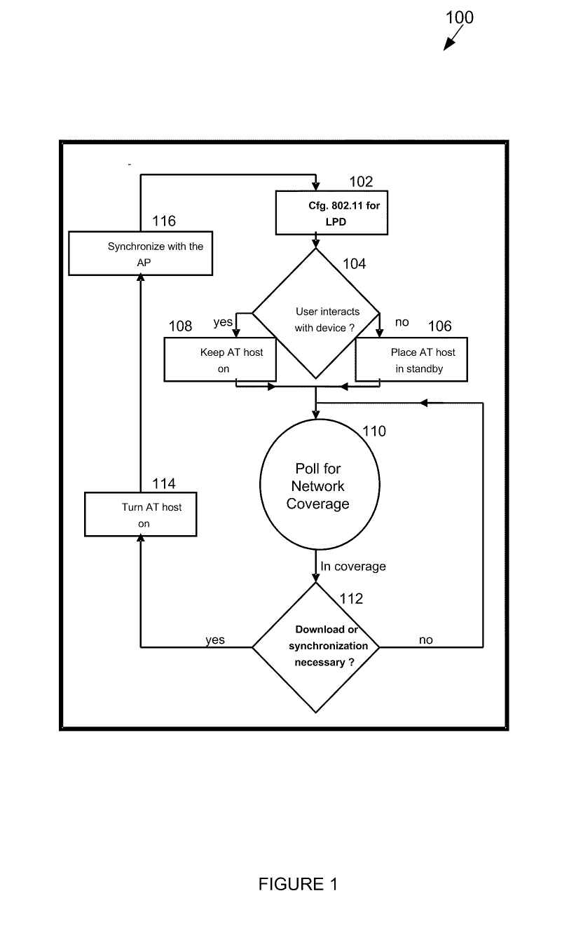

Because battery lifetime is a chief concern in portable devices with 802.11 interfaces, the novel wakeup processes extend the battery lifetime by increasing the probability that the device is turned on only when the there is an appropriate 802.11 network Access Point (AP) in the vicinity which, is able to provide desired services (such as e-mail verification, downloads, etc.). In the trigger scanning embodiment, a trigger scanning process utilizes probabilistic channel scanning and optional additional sensors such as GPS, gyroscope, Bluetooth, etc to wake up the device. An optional synchronization token helps the network AP server decide whether to trigger device wake-up and assists the Bluetooth device in using additional information such as the existence of encryption or new user email or data in deciding whether to wake up the AT host processor. In the Inquiry Access Code (IAC) embodiment, an advertisement process at the network AP is equipped with a Bluetooth inquiring process, which advertises network coverage availability and initiates the wake-up process with a special inquiry access code (IAC). The Bluetooth device looks for a certain IAC. Upon receiving the IAC, the Bluetooth device sends a Bluetooth inquiry reply directing the AP to wake the Bluetooth device host processor via a wake-up packet. An exemplary embodiment of the trigger scanning process is detailed in FIGS. 1-5. An exemplary embodiment of the IAC process is detailed in FIGS. 6-11.

FIG. 1 illustrates an overview of an exemplary implementation of a trigger scanning low power wake up process 100. Probabilistic scanning allows the use of sensors and historical or pre-loaded information to improve the probability that 802.11 scanning is not required on individual channels to further reduce power needs. Also, probabilistic scanning does not require wireless interfaces beyond 802.11, although it allows for use of such interfaces, if available. Channels are scanned probabilistically based on such criteria as history of found channels or triggers (where relevant), pre-programmed trigger information downloaded from the server, or information from other sensors (GPS, Bluetooth, Gyroscope, Odometer, Cellular signal) pertaining to the likelihood of an 802.11 channel.

A Bluetooth device equipped with an 802.11 interface is brought to a standby or equivalent sleep state when it is deemed that the 802.11 interface is idle (e.g. download finished, watchdog timer expired since last in coverage or since last user input, etc) or the Bluetooth device host processor has been idle for a predetermined duration. Before going to sleep, the Bluetooth device host processor instructs the 802.11 Wireless Local Area Network (WLAN) to wake it up based on a predetermined trigger. The host processor also updates the synchronization token and downloads it to the MAC processor. The token may mark a level of download that has been reached, changes in some download list, latest retrieved e-mail and so forth. For example, the token identifies conditions when it is not necessary to wake in order to download email or other data that has already been fetched from the server and is therefore, not new. Trigger logic may be implemented in the MAC processor firmware, which is already found in modern 802.11 interfaces.

A trigger to wake up the Bluetooth device host processor is received from an AP by scanning all 802.11 channels (in the 2.4 or 5 GHz bands) for criteria such as a desired (Service Set Identifier) SSID, desired encryption, a special packet format from the AP, or wake-up necessity indicated through a synchronization token transmitted by the Bluetooth device. The synchronization token may be unencrypted to accommodate limited MAC processor capability. The synchronization token is sent by the Bluetooth device to the AP when desired 802.11 coverage is found. The Bluetooth device's MAC address allows the AP to wake-up only specific Bluetooth devices, on the basis of the need for wake-up, as determined after analyzing the Bluetooth device's synchronization token.

The Bluetooth device's MAC address can be used by the AP server to identify which devices actually require wake up using existing low level 802.11 processing capability already available without any additional hardware or chipsets. If a wakeup is sent to the Bluetooth's device's 802.11 interface, the device must know which 802.11 channel to tune to. The desired channel information can be sent to the AP server along with the MAC address of the device. The Bluetooth device looks for the wake up pattern on the specified channel should the server decide to send it. If the Bluetooth proximity is insufficient for wake up (i.e. we can detect a Bluetooth signal but in our application that is not enough for waking up) then the device may send a Bluetooth inquiry to the server with a synchronization token if it is available, or use an 802.11 packet on the specified channel. For example, when a Bluetooth device detects a Bluetooth beacon, i.e. the device is near an area of network coverage, it could be sufficient for wakeup, but if the Bluetooth device requires more information to determine wakeup necessity, it may send further inquiry through either Bluetooth or 802.11. In both cases the reply comes from the server and includes the MAC address and the synchronization token.

Even if the Bluetooth device is out-of-coverage, the device's host processor may still be awake during low power discovery (LPD), due to the user interacting with the device (reading e-mails, viewing movies, etc). The user may be operating a third-party peripheral or software that requires the Bluetooth device host to be awake. In the disclosed embodiments, the LPD process is intended to run regardless of whether the host processor is on or in standby mode. When exiting 802.11 coverage, the LPD procedure starts regardless of whether the host processor can or cannot be put in standby mode. The Bluetooth device host processor may still enter standby at some later point, after, for instance, a watchdog timer monitoring user activity expires or the user finishes watching a movie. The process whereby a Bluetooth device host processor may enter or exit standby mode runs asynchronously from the LPD process. Interaction between the LPD process and the host standby/on status process occurs when desired coverage is exited (wherein the LPD process places the host processor in standby if nothing else compels the host processor to remain on) or desired network coverage is detected, wherein the LPD process turns the host processor on, if it is not already on, and notifies it of the newly discovered network coverage. The following process diagrams illustrate LPD process functionality. Other than being awake when synchronizing with the network AP server, the Bluetooth device host processor may or may not be in standby at any specific time, as required by user interaction. Nevertheless, the LPD process is intended to ensure that the Bluetooth device host processor is in standby whenever possible.

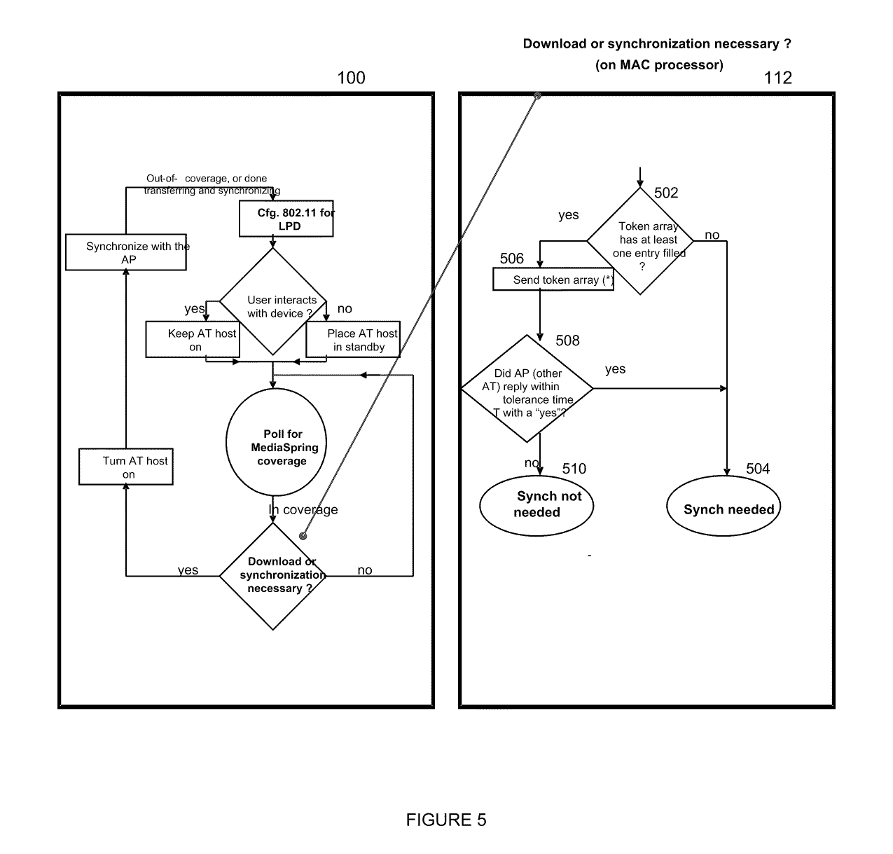

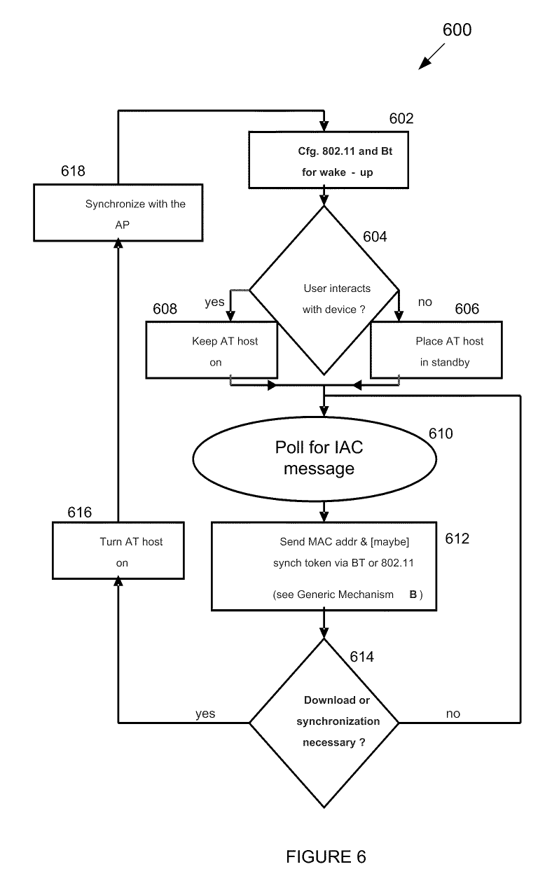

This synchronization component is detailed below in FIG. 5.

In step 114, the device host processor is removed from standby mode to a fully powered an on state. Control flow proceeds to step 116.

In step 116, the WiFi interface of the Bluetooth device is synchronized with the newly acquired AP server of the available network. Control flow returns to step 102, where the Bluetooth device is configured with updated synchronization and network information pertaining to the new coverage.

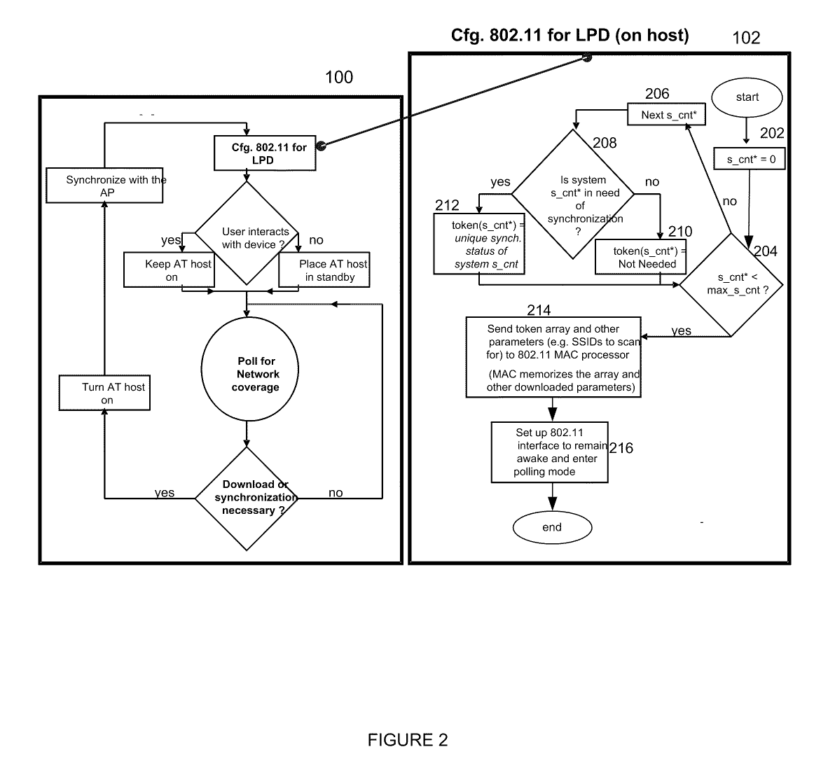

FIG. 2 details an exemplary 802.11 configuration component 102 of the trigger scanning low power discovery and wake up process 100. In step 202, a host logical system count variable is initialized to zero. Examples of host logical systems are email, movie downloads, stock price updates and so forth. The configuration component loops through all of the Bluetooth device host logical systems in order to synchronize each system requiring update with the present network AP. Control flow proceeds to step 204.

In step 204, the value of the host logical system count variable is compared to a maximum system count value, i.e. the total number of host logical systems, to determine if every host logical systems has been synchronized. When the system count equals the total number of host logical systems, i.e. it has reached the maximum system count, every host logical system has been synchronized and control flow proceeds to step 214. Otherwise, Control flow proceeds to step 206 where the synchronization of a next host logical system is initiated.

In step 206, the host logical system count is incremented. Control flow proceeds to step 208.

In step 208, it is determined whether the current host logical system requires synchronization with the present network AP. If no synchronization update is necessary, control flow proceeds to 210 where a token requirement variable is assigned a value indicating no synchronization is necessary for this host logical system. Otherwise, control flow proceeds to step 212 where the token requirement variable is assigned a value identifying the host logical system requiring synchronization update. From either step 210 or step 212, control flow returns to step 204 to determine whether this host logical was the last host logical system to be examined for synchronization necessity.

In step 214, an array of token requirement values having a token value for each host logical system of the Bluetooth device is sent to the present network AP. The array may also comprise and other parameters such as SSIDs the Bluetooth device is scanning for or various parameters for download to the 802.11 MAC processor. The array and other downloaded parameters may be stored in the MAC layer of the Bluetooth device. Control flow proceeds to step 216.

In step 216, the 802.11 interface is configured to remain awake and enter polling mode, ending the 802.11 configuration component 102 of the trigger scanning low power wake up process 100.

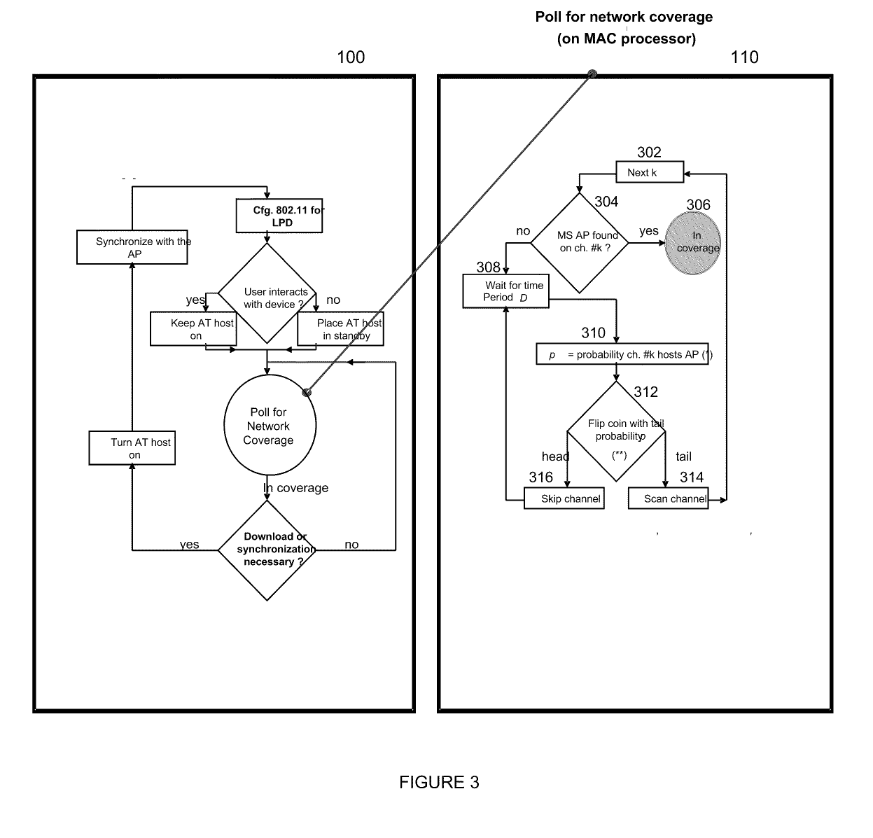

FIG. 3 details an exemplary network coverage polling component 110 of the trigger scanning low power discovery and wake up process 100. Polling for network coverage begins in step 302 where the polling process advances to a next possible 802.11 channel where a network AP may be found represented by the variable k. Control flow proceeds to step 304.

In step 304, a network AP is sought on channel k. If a network AP is found on channel k, control flow proceeds to step 306 where the Bluetooth device acquires network coverage on channel k and the network coverage polling process ends. When a network AP is not found on channel k, control flow proceeds to step 308.

In step 308, the network coverage polling process waits, i.e idles, for a time period represented by the variable D. Control flow proceeds to step 310.

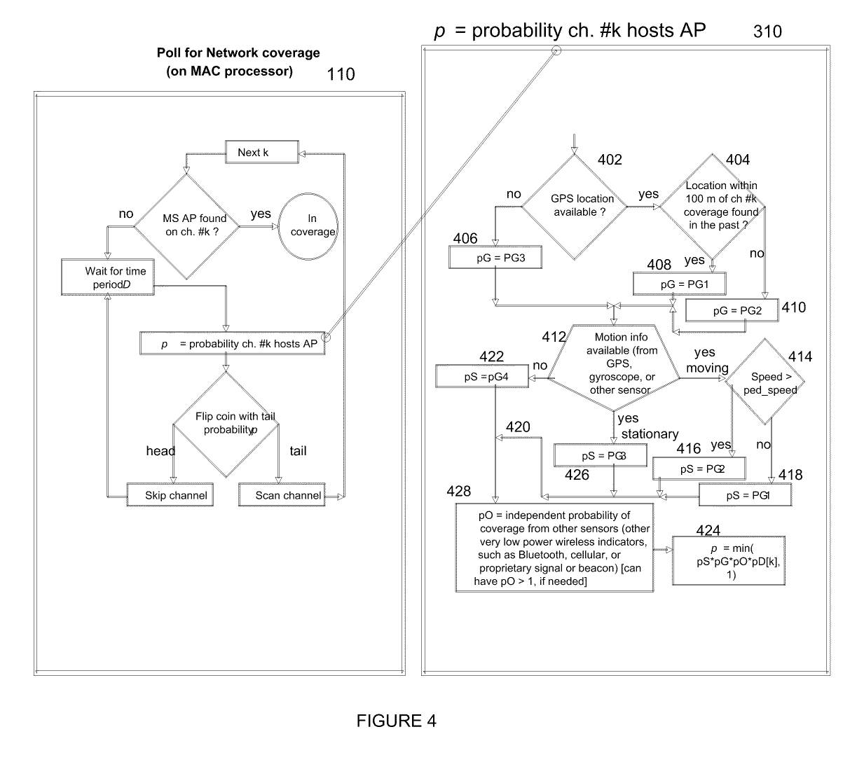

In step 310, a probability p equaling the probability that a network AP will be found on channel k is computed. The probability p can be computed from historical data, interference reports, planning reports, possibly passed during the configuration of the 802.11 interface priori to device sleep, other environment sensors (e.g. GPS, motion detector), etc. It might have a minimum value. This computation equalizes the time spent scanning each channel k. The computation of p is detailed in FIG. 4. Control flow proceeds to step 312.

In step 312, a calculation with two possible outcomes, i.e. the flip of a coin (heads or tails) with one outcome (tail) having the probability p determines control flow. If the tail probability is calculated, i.e there is a higher probability there is a network AP available on channel k, control flow proceeds to step 314 where channel k is scanned for a network AP and the next polling iteration begins again in step 302. If the head probability is calculated, control flow proceeds to step 316.

In step 316, channel k, having a lower probability of a network AP is skipped, or not scanned. Control flow returns to step 308 where the process continues until network coverage is established.

FIG. 4 details an exemplary probability calculation 310 of the network coverage polling component 110 of both embodiments of the low power discovery and wake up process. Probabilistic channel scanning may use additional speed and other sensors to detect individual channel scanning necessity. For example, if the portable Bluetooth device is located in a car traveling at 100 Km/hr, the probability of acquiring WiFi coverage will be low because the signal will only be present for a very brief period of time. Alternately, if the Bluetooth device is not moving, i.e. remains in the same spot, there is no point in performing frequent scanning because the network coverage availability will remain constant. When sensors detect that the device is moving again, then scanning frequency is again increased on that individual channel. Internal variables representing probabilities are assigned constant values determined by the application according to physical circumstances. PG1, PG2 and PG3, PS1, PS2, PS3, representing probabilities are set to constant values by the application. Exemplary values are, for instance: PG1=1, PG2=PG4=0.1, PG3=0, PS1=1, PS2=0.01, PS3=0.1, ped_speed=5 mph. pD is an array with a-priory probabilities of different channels, possibly downloaded from the AP when the Bluetooth device is awake.

The probability calculation begins in step 402, which determines whether a GPS location can be obtained. If a GPS location is obtainable, control flow proceeds to step 404. Otherwise, when no GPS location is obtainable, control flow proceeds to step 406 where internal variable pG is set to equal the value of the constant PG3 and control flow proceeds to 412.

Step 404, determines whether the obtained GPS location is within 100 meters of past coverage found on channel k. If the obtained GPS location is within 100 meters of past coverage found on channel k, control flow proceeds to step 408 where internal variable pG is set to equal the value of the constant PG1 and control flow proceeds to 412. If the obtained GPS location is not within 100 meters of past coverage found on channel k, control flow proceeds to step 410 where internal variable pG is set to equal the value of the constant PG2 and control flow proceeds to 412.

In step 412, if motion information from GPS, gyroscope or other sensors is available and indicates the device is moving, control flow proceeds to step 414. If motion information from GPS, gyroscope or other sensors is available and indicates the device is stationary, control flow proceeds to step 422 where internal variable pS is set to equal the value of the constant PG3 and control flow proceeds to step 428. If motion information from GPS, gyroscope or other sensors is not available, control flow proceeds to step 416 where internal variable pS is set to equal the value of the constant PG4 and control flow proceeds to step 428.

In step 414, the speed measured by the sensor is compared to the constant value of the internal variable ped_speed. If the measured speed value is less than the constant value of ped_speed, control flow proceeds to step 418 where internal variable pS is set to equal the value of the constant PG1 and control flow proceeds to step 428. Otherwise, if the measured speed value is greater than the constant value of ped speed, control flow proceeds to step 420 where internal variable pS is set to equal the value of the constant PG2 and control flow proceeds to step 428.

In step 428, the pO array value of pD is set to equal the independent probability of coverage from other sensors comprising other very low power wireless indicators, such as Bluetooth, cellular, or a proprietary signal or beacon. (pO can have a value pO>1, if needed.) Control flow proceeds to step 426 where p is set to equal min(pS*pG*pO*pD[k], 1) and is returned to the polling for coverage process.

FIG. 5 details an exemplary synchronization component 112 of the trigger scanning low power discovery and wake up process 100. Synchronization begins in step 502, which determines whether the synchronization token array produced in step 214 of FIG. 2 contains at least one entry. If the token array is empty, control flow proceeds to step 504 where synchronization is determined to be necessary and the synchronization component returns to step 214 of FIG. 2. If the token array is not empty, control flow proceeds to step 506.

In step 506, the Bluetooth device sends the token array to the network AP. In one embodiment, this transmission may be a non-standard request, possibly in the form of an association request at the lowest data rate, with the token array sent in a proprietary information element. The AP reply could be a similar proprietary message such as an ACK, a NACK, or an association reply with a proprietary format. Control flow proceeds to step 508.

Step 508 determines whether the AP replied within a predetermined tolerance time period. If the AP reply was received within the predetermined time period, control flow proceeds to step 504 where synchronization is determined to be necessary and the synchronization components returns to step 214 of FIG. 2. Otherwise, control flow proceeds to step 510 where synchronization is determined to be unnecessary and the synchronization components returns to step 214 of FIG. 2.

The IAC Inquiry Access Code (IAC) embodiment, wherein an advertisement process at the network APs advertises network coverage availability to Bluetooth devices within range and initiates the wake-up process with a special IAC, is detailed in FIGS. 6-11.

Rather than scanning for wakeup triggers, this embodiment device inquiry process defines a special Bluetooth IAC transmitted by network APs to initiate a discovery process with the Bluetooth device that does not require the existence of additional processors or alternative channels. The inquiry process may be implemented in 802.11 Media Access Control (MAC) processor firmware. While in standby mode, the Bluetooth device polls for a certain inquiry access code (or invitation from the AP server). When an IAC is detected, the Bluetooth device a sends an inquiry response to the AP server comprising its MAC address and synchronization token(s). The server uses the 802.11 interface to send a wake up packet to the Bluetooth device if synchronization is necessary. The disclosed discovery may be partially managed through Bluetooth, as the server itself has a Bluetooth device for transmitting signals. The Bluetooth device may activate its 802.11 interface at the same time it asks for more information from the server, such that the server can confirm or deny the necessity for wakeup. In other words, the Bluetooth device is programmed to look for certain IACs via Bluetooth communications. Upon finding the IAC, the Bluetooth device sends a Bluetooth inquiry reply directing the AP to wake the Bluetooth host processor via a wake-up packet if necessary. The Bluetooth device may ask for more advice or information from the AP in the wakeup decision making process.

FIG. 6 illustrates an overview of an exemplary implementation of an IAC low power discovery and wake up process 600. Beginning in step 602, the 802.11 WiFi interface and the Bluetooth interface of the portable Bluetooth device are configured for Low Power Discovery functionality. Control flow proceeds to step 604.

In step 604, the Bluetooth device determines whether the user is currently interacting with the device. If the user is interacting with the device, control flow proceeds to step 608 where the device's host processor remains fully powered and on. Otherwise, control flow proceeds to step 606 where the device's host processor is placed in power conserving standby mode. From either step 606 or 608, control flow proceeds step 610.

In step 610, the Bluetooth device continuously to polls for an IAC until an IAC is received on its Bluetooth interface. When an IAC is found, control flow proceeds to step 612.

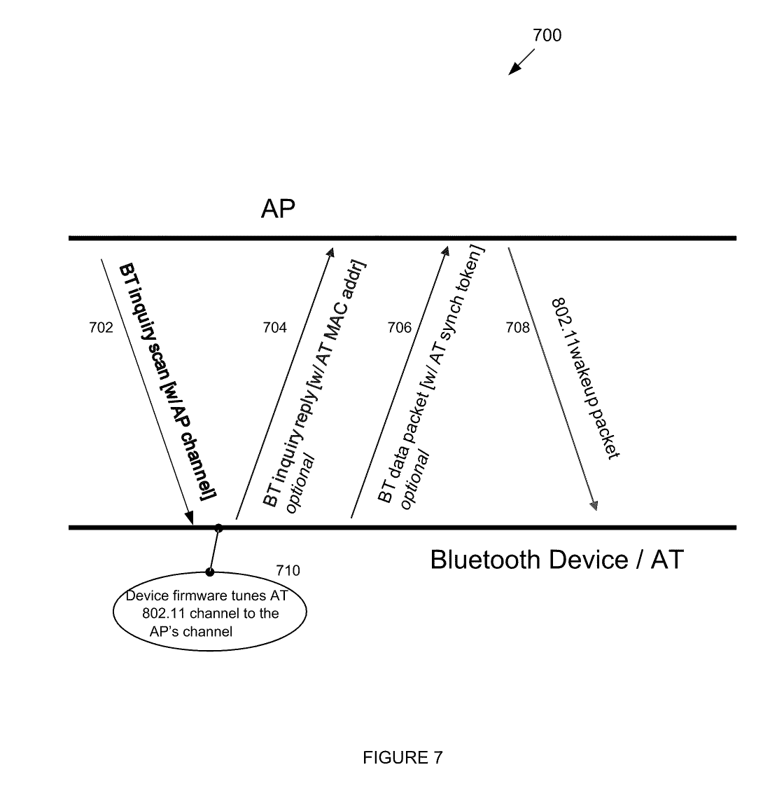

In step 612, the Bluetooth device sends a Bluetooth inquiry reply to the AP. The reply may comprise its MAC address, synchronization token(s), and/or requests for wakeup decision making support. The replies may be sent to the AP via either the device's Bluetooth or 802.11 interface. IAC messaging between the Bluetooth device and the AP in the IAC embodiment is detailed in FIGS. 7-9. Control flow proceeds to step 614.

In step 614, the Bluetooth device determines whether any download or synchronization with the network is necessary. If no new data or other condition necessitates synchronization, control flow returns to step 610. Otherwise, control flow proceeds to step 616.

In step 616, the device host processor is removed from standby mode to a fully powered an on state. Control flow proceeds to step 618.

In step 618, the Bluetooth device is synchronized with the newly acquired AP server of the available network. Control flow returns to step 602, where the Bluetooth and 802.11 interfaces are configured with updated wake up information.

FIG. 7 is an exemplary messaging diagram for an IAC low power discovery and wakeup process where inquiry replies from the device are transmitted via the device's Bluetooth interface 700. Messaging exchanges between the Bluetooth device and the network coverage AP begin with IAC message scanning by the Bluetooth device via its Bluetooth interface 702. The desired inquiry from the Bluetooth equipped AP is sent to advertise the availability of the 802.11 AP, as well as (optionally) the AP's 802.11 channel. The inquiry can be sent in various forms, such as a Dedicated Inquiry Access Code [DIAC], with its Lower Access Portion [LAP] corresponding to an unusual device or as a special kind of Inquiry Access Code [IAC], neither General [GIAC], nor dedicated, by using a special Most Significant Bits [MSB] field [MOR02]. The 802.11 channel is optionally sent in a Bluetooth data packet with the IAC so that the device firmware tunes the 802.11 interface to the advertised AP channel. If no 802.11 channel information is sent by the AP, the device firmware has the option of either waking up the device host processor and handling 802.11 channel scanning to it or using a Bluetooth packet to send a synchronization token to the AP, along with the device's 802.11 channel number.

If the AP's initial inquiry included a packet number, or the device firmware sends a synchronization token to the AP, along with the device's 802.11 channel number, the firmware on the device sends either a Bluetooth inquiry reply, informing the AP of the device's vicinity, followed by an optional synchronization token packet through a regular Bluetooth packet or an 802.11 packet on the specified channel (possibly in the form of an association request), with a synchronization token. The AP then targets, depending on the synchronization token, a wakeup packet (such as a magic packet) to the device's 802.11 interface. To target the wake-up packet, the AP uses the device's MAC address (or other unique identifier). The 48-bit MAC address (or other pattern to match) for the wakeup packet has been sent by this time either through the Bluetooth inquiry reply or through the MAC address field of the standard 802.11 association request frame.

When the Bluetooth device detects the IAC message from the AP broadcasting network coverage availability on its Bluetooth interface, the Bluetooth device tunes to the 802.11 channel advertised by the AP (if available) 710. The Bluetooth device optionally transmits an inquiry reply with its MAC address on its Bluetooth interface 704. The Bluetooth device also optionally transmits an inquiry reply comprising synchronization token(s) on its Bluetooth interface 706. The AP responds with a wakeup packet via its 802.11 interface on the advertised channel 708.

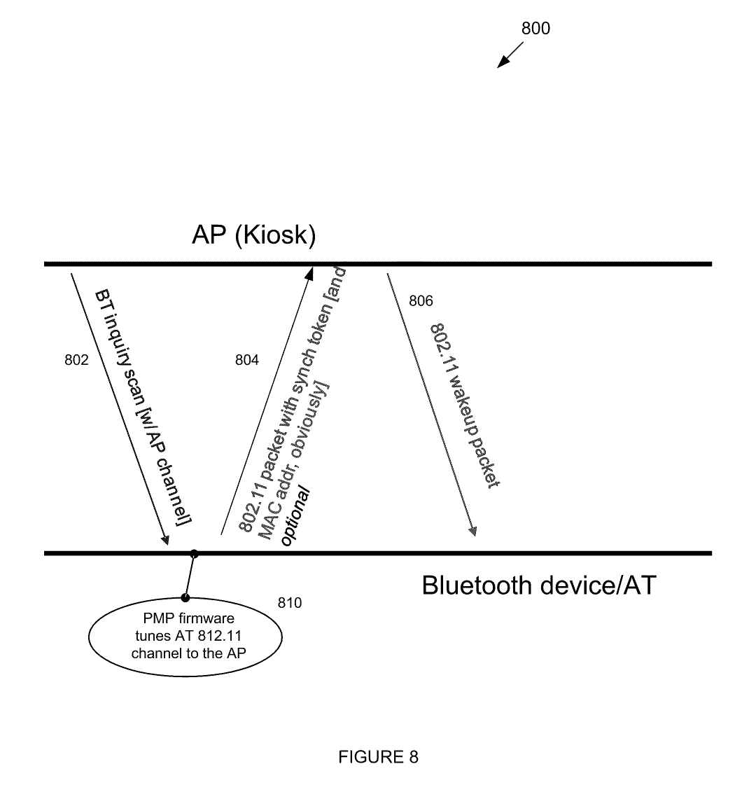

FIG. 8 is an exemplary messaging diagram for an IAC low power discovery and wakeup process where inquiry replies from the device are transmitted via the device's 802.11 interface 800. Messaging exchanges between the Bluetooth device and the network coverage AP begin with IAC message scanning by the Bluetooth device via its Bluetooth interface 802. When the Bluetooth device detects the IAC message from the AP broadcasting network coverage availability on its Bluetooth interface, the Bluetooth device tunes to the 802.11 channel advertised by the AP 810. The Bluetooth device optionally transmits an inquiry reply with its MAC address and optional synchronization token(s) on its 802.11 interface using the channel advertised by the AP 804. The AP responds with a wakeup packet via its 802.11 interface on the advertised channel 806.

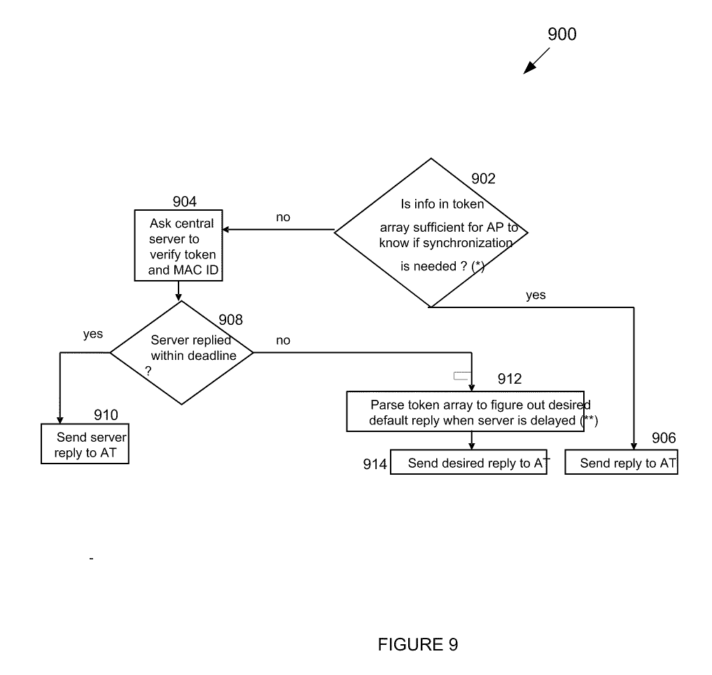

FIG. 9 is a flowchart illustrating an exemplary use of synchronization token information by network coverage Access Points 900. When synchronization token information is received by an AP, the AP determines whether the information in the token array is sufficient for the AP decide if the Bluetooth device requires synchronization 902. If there is enough information in the token array for the AP determine that device requires synchronization, control flow proceeds to step 906 wherein the AP sends a wakeup packet response to the device. If there is insufficient information, control flow proceeds to step 904.

In step 904, the AP makes an inquiry to its central network server to verify the MAC ID and token information received from the device. Control flow proceeds to step 908.

In step 908, the AP determines whether a timely reply having additional synchronization information has been obtained from the central network server. If a reply has been obtained, the AP forwards the synchronization information from the server to the device, thus synchronizing the device 910. Otherwise, control flow proceeds to step 912.

In step 912, the AP extracts a desired default reply from the synchronization token information received from the device. Control flow proceeds to step 914 where the AP sends the default reply to the device, thus synchronizing the device with default synchronization.

Note that a Bluetooth device in standby detecting coverage is not associated yet such that sending a token requires a special mechanism. On order to avoid requiring a large part of the higher-layer MAC to be implemented in firmware, the token transmission message from the device (706, 804) may comprise an association request at the lowest modulation and coding rate (to ensure reception and minimize logic), where the synchronization token is encoded in one or more a Vendor Specific information elements. The synch token reply may come in the form of an association reply (reject), with the actual reply sent on relevant Vendor Specific information elements includes a synchronization sample, which could offload wake-up decision to the AP, rather than a non-simplistic device implementation.

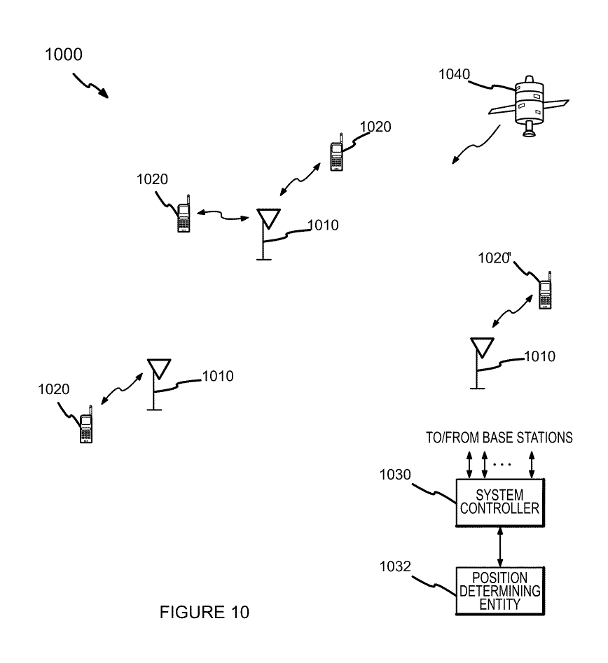

FIG. 10 shows an exemplary wireless multiple-access communication network 1000 within which the disclosed apparatus and methodology for low power discovery and wakeup discovery may be implemented. Network 1000 comprises multiple base stations 1010, with each base station providing communication coverage for a particular geographic area (i.e. a sector or a cell).

Base station 1010 is generally a fixed station that communicates with wireless devices 1020. Base station 1010 may also be called an access point (AP), a Node B, a beacon, or other terminology. A “cell” refers to a base station and/or its geographical coverage area depending on the context in which the term is used. Base stations 1010 may have coverage areas of different sizes and shapes, determined by various factors such as terrain, obstructions, and other topographical considerations. To improve system capacity, a base station 1010 coverage area may be partitioned into multiple smaller areas, or sectors, served by a respective base transceiver subsystems (BTSs). For simplicity, in the following description, the term “base station” generically refers to a fixed station that serves a sector as well as a fixed station that serves a cell.

System controller 1030 couples to base stations 1010 to provide coordination and control for base stations 1010. System controller 1030 may be a single network entity or a collection of network entities. System controller 1030 may comprise one or more of a Base Station Controller (BSC), a Mobile Switching Center (MSC), a Radio Network Controller (RNC), a Packet Data Serving Node (PDSN), or other network entities.

Position Determining Entity (PDE) 1032 supports position determination for wireless devices 1020. PDE 1032 may provide assistance data used by wireless devices 120 to determine position. PDE 1032 may also compute position estimates for wireless devices 1020 based on ranging measurements provided by wireless devices 120 and/or base stations 1010.

Wireless devices 1020 are typically dispersed throughout network 1000. Each Wireless device 1010 may be fixed or mobile. Wireless devices 1020 may communicate with zero, one, or multiple base stations 1010 on the forward and reverse links at any given time. Wireless devices 1020 may also receive signals from Satellite 1040 belonging to a Global Positioning System (GPS), Galilco and/or other satellite positioning or communication systems, each referred to generally herein as a Satellite Positioning System (SPS). Wireless device 1010 may decode signals transmitted from satellite 1040 for the purpose of determining location, velocity or time. To decipher satellite 1040 signals and compute a final location, wireless device 1020 must acquire signals from the satellites 1040 in view, measure and track the received signals, and recover navigational data from the signals. By accurately measuring the distance from three different satellites 1040, the receiver triangulates its location, (i.e., solves for latitude, longitude and altitude). If adequate satellite 1040 signals are unavailable, wireless device 1020 may use signals from base stations 110 to determine location. As with satellite 1040 signals, wireless device 1020 measures distances from base stations 1010 of wireless network 1000. Wireless device 1020 may utilize a combination of signals from base stations 1010 and acquired signals from satellites 1040, to determine location and time.

This location and time information is utilized to enhance wireless device 1020 functionality and feature interoperability. Low power device wakeup and discovery functionality may be implemented in wireless device 1020, base stations 1010, system controller 1030, PDE 1032, or at any other network entity.

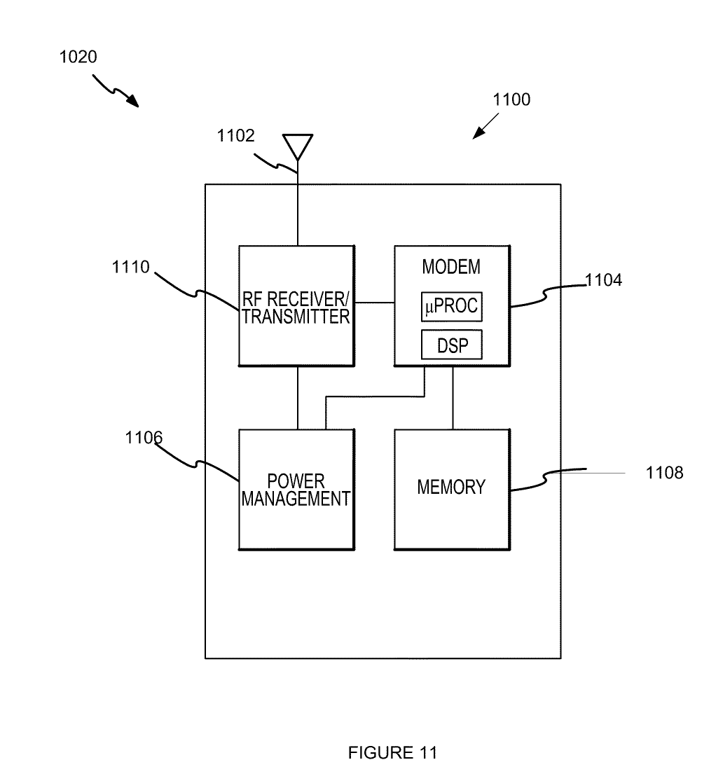

FIG. 11 is a basic component block diagram of an exemplary wireless Bluetooth device 1100 having capability for providing low power wakeup and discovery disclosed in FIGS. 1-9. Wireless device 1100 comprises a wireless communication transceiver 1110 and associated antenna 1102 capable of sending and receiving wireless communication signals. Modem 1104 comprises the appropriate microprocessor(s), digital signal processor(s) and other suitable hardware, such as a correlator bank, for processing signals. Power management 1106 controls power for various components of wireless device 1100. Memory 1108 is coupled to modem 1104 as necessary for implementing various modem processes including Bluetooth and 802.11 communications. Wireless device 1100 comprises an appropriate user interface with alphanumeric keypad, display, microphone, speaker, and other necessary components (not shown).

It will be appreciated by those skilled in the art that wireless device 1100 may comprise a variety of components not shown. The methodology described herein may be implemented by suitable instructions operating on the microprocessor and memory of wireless device 1100, but is certainly not limited to such an implementation.

Thus, a novel and improved method and apparatus for low power discovery and wake up using service set identifiers, probalistic scanning, optional sensors, and synchronization verification and have been described. The host processor is never unnecessarily awake. Additional processor or processor hierarchies in the host are not required, but rather, advantageous use of MAC processing capabilities already available in 802.11 hardware is made. The presently disclosed methods and apparatus do not require more than a WLAN interface dedicated to wakeup or maintenance of an application state masquerading as the device host. The trigger scanning embodiment does not require an additional paging channel or protocol, but rather relies on reducing form-factor, simplifying hardware, and taking advantage of advances in power-saving techniques in 802.11. The IAC embodiment makes advantageous use of inherent power savings of Bluetooth, while letting the device host processor know what channel to tune to. The wake-up can optionally be targeted to the device host, depending on synchronization token analysis by the AP. A great degree of flexibility is provided in triggering wake-up, by multiple-channel scanning for triggers or channel tuning via IAC information.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for low power discovery and wakeup comprising:
performing probalistic channel scanning for a wakeup trigger based on sensor information;
determining if wakeup and/or synchronization is required by a Bluetooth device equipped with an 802.11 interface; and
conserving power in the Bluetooth device by initiating wakeup and/or synchronization of the Bluetooth device only when required.

2. The method of low power discovery and wakeup of claim 1 wherein sensor information comprises information from GPS, gyroscope, odometer, Bluetooth or cellular signals.

3. The method of low power discovery and wakeup of claim 1 wherein the determining if wakeup and/or synchronization is required is based on information contained in a synchronization token exchanged between the Bluetooth device and a network coverage Access Point.

4. The method of low power discovery and wakeup of claim 1 wherein the wakeup trigger comprises a Service Set Identifier, desired encryption, a special packet format from a network coverage Access Point, or wake-up necessity indicated through a synchronization token.

5. The method of low power discovery and wakeup of claim 1 wherein the wakeup trigger comprises a Bluetooth Inquiry Access Code.

6. The method of low power discovery and wakeup of claim 4 wherein a response to the Inquiry Access code is made from the Bluetooth device via a Bluetooth communication channel and a wake up packet is received by the Bluetooth device via an 802.11 communication channel.

7. The method of low power discovery and wakeup of claim 4 wherein a response to the Inquiry Access code is made by the Bluetooth device via an 802.11 communication channel and a wake up packet is received by the Bluetooth device via an 802.11 communication channel.

8. A processor for low power discovery and wakeup, the processor configured to:
perform probalistic channel scanning for a wakeup trigger based on sensor information;
determine if wakeup and/or synchronization is required by a Bluetooth device equipped with an 802.11 interface; and
conserve power in the Bluetooth device by initiating wakeup and/or synchronization of the Bluetooth device only when required.

9. The processor for low power discovery and wakeup of claim 8 wherein sensor information comprises information from GPS, gyroscope, odometer, Bluetooth or cellular signals.

10. The processor for low power discovery and wakeup of claim 8 wherein the determining if wakeup and/or synchronization is required is based on information contained in a synchronization token exchanged between the Bluetooth device and a network coverage Access Point.

11. The processor for low power discovery and wakeup of claim 8 wherein the wakeup trigger comprises a Service Set Identifier, desired encryption, a special packet format from a network coverage Access Point, or wake-up necessity indicated through a synchronization token.

12. The processor for low power discovery and wakeup of claim 8 wherein the wakeup trigger comprises a Bluetooth Inquiry Access Code.

13. The processor for low power discovery and wakeup of claim 12 wherein a response to the Inquiry Access code is made from the Bluetooth device via a Bluetooth communication channel and a wake up packet is received by the Bluetooth device via an 802.11 communication channel.

14. The processor for low power discovery and wakeup of claim 12 wherein a response to the Inquiry Access code is made by the Bluetooth device via an 802.11 communication channel and a wake up packet is received by the Bluetooth device via an 802.11 communication channel.

15. A wireless communications device, comprising:
a processor for performing probalistic channel scanning for a wakeup trigger based on sensor information and determining if wakeup and/or synchronization is required by a Bluetooth device equipped with an 802.11 interface; and
a power management circuit for conserving power in the Bluetooth device by initiating wakeup and/or synchronization of the Bluetooth device only when required.

16. The wireless communications device of claim 15 wherein sensor information comprises information from GPS, gyroscope, odometer, Bluetooth or cellular signals.

17. The wireless communications device of claim 15 wherein the determining if wakeup and/or synchronization is required is based on information contained in a synchronization token exchanged between the Bluetooth device and a network coverage Access Point.

18. The wireless communications device of claim 15 wherein the wakeup trigger comprises a Service Set Identifier, desired encryption, a special packet format from a network coverage Access Point, or wake-up necessity indicated through a synchronization token.

19. The wireless communications device of claim 15 wherein the wakeup trigger comprises a Bluetooth Inquiry Access Code.

20. The wireless communications device of claim 19 wherein a response to the Inquiry Access code is made from the Bluetooth device via a Bluetooth communication channel and a wake up packet is received by the Bluetooth device via an 802.11 communication channel.

21. The wireless communications device of claim 19 wherein a response to the Inquiry Access code is made by the Bluetooth device via an 802.11 communication channel and a wake up packet is received by the Bluetooth device via an 802.11 communication channel.

22. An apparatus for low power discovery and wakeup comprising:
means for performing probalistic channel scanning for a wakeup trigger based on sensor information and determining if wakeup and/or synchronization is required by a Bluetooth device equipped with an 802.11 interface; and
means for power management for conserving power in the Bluetooth device by initiating wakeup and/or synchronization of the Bluetooth device only when required.

23. The apparatus of claim 22 wherein sensor information comprises information from GPS, gyroscope, odometer, Bluetooth or cellular signals.

24. The apparatus of claim 22 wherein the determining if wakeup and/or synchronization is required is based on information contained in a synchronization token exchanged between the Bluetooth device and a network coverage Access Point.

25. The apparatus of claim 22 wherein the wakeup trigger comprises a Service Set Identifier, desired encryption, a special packet format from a network coverage Access Point, or wake-up necessity indicated through a synchronization token.

26. The apparatus of claim 22 wherein the wakeup trigger comprises a Bluetooth Inquiry Access Code.

27. The apparatus of claim 26 wherein a response to the Inquiry Access code is made from the Bluetooth device via a Bluetooth communication channel and a wake up packet is received by the Bluetooth device via an 802.11 communication channel.

28. The apparatus of claim 22 wherein a response to the Inquiry Access code is made by the Bluetooth device via an 802.11 communication channel and a wake up packet is received by the Bluetooth device via an 802.11 communication channel.

29. A computer program product, comprising:
a computer-readable medium comprising:
code for performing probalistic channel scanning for a wakeup trigger based on sensor information;
code for determining if wakeup and/or synchronization is required by a Bluetooth device equipped with an 802.11 interface; and
code for conserving power in the Bluetooth device by initiating wakeup and/or synchronization of the Bluetooth device only when required.

30. The computer program product of claim 29 wherein sensor information comprises information from GPS, gyroscope, odometer, Bluetooth or cellular signals.

31. The computer program product of claim 29 wherein the determining if wakeup and/or synchronization is required is based on information contained in a synchronization token exchanged between the Bluetooth device and a network coverage Access Point.

32. The computer program product of claim 29 wherein the wakeup trigger comprises a Service Set Identifier, desired encryption, a special packet format from a network coverage Access Point, or wake-up necessity indicated through a synchronization token.

33. The computer program product of claim 29 wherein the wakeup trigger comprises a Bluetooth Inquiry Access Code.

34. The computer program product of claim 33 wherein a response to the Inquiry Access code is made from the Bluetooth device via a Bluetooth communication channel and a wake up packet is received by the Bluetooth device via an 802.11 communication channel.

35. The computer program product of claim 33 wherein a response to the Inquiry Access code is made by the Bluetooth device via an 802.11 communication channel and a wake up packet is received by the Bluetooth device via an 802.11 communication channel.
